(19) United States
(12) Patent Application Publication
(10) Pub. No.: US 2014/0214727 A1
(43) Pub. Date: Jul. 31, 2014

(54) DATE MANAGEMENT SYSTEM

(71) Applicant: NEOPOST TECHNOLOGIES, BAGNEUX (FR)

(72) Inventors: Olivier BECHIR, Massy (FR); Bruno ROSTAING, Senlisse (FR)

(73) Assignee: NEOPOST TECHNOLOGIES, BAGNEUX (FR)

(21) Appl. No.: 14/166,293

(22) Filed: Jan. 28, 2014

(30) Foreign Application Priority Data
Jan. 29, 2013 (EP) 13 30 5101

(51) Int. Cl. G06Q 50/32

(52) U.S. Cl. CPC G06Q 50/32
USPC 705/409

(57) ABSTRACT

Method allowing a mailing system to frank in advance and manage a large number of rate tables stored in the mailing system, and in particular providing the possibility to frank mail in advance using a new future rate table and to come back later to franking with today's date and using a previous rate table, and including the main steps: provision of a control module, which can store more than two rate tables in a non-volatile memory accessible by the control module, provision of a volatile memory which can store the active rate table that is currently used by the mailing system for franking mail pieces, selection by the control module of the active rate table amongst the rate tables stored in a non-volatile memory when the mailing system is powered on and loading of this active rate table by the control module in volatile memory, initiation by the control module of the change of the active rate table triggered by determined events, selection by the control module of a new rate table based on the franking date defined by the operator or by the mailing system and the application date of the new rate table.

### TECHNICAL FIELD

The present invention relates to the field of mail processing devices and more particularly to the management of the date, which is printed on a mail piece with the mail carrier marking, and the management of the rate tables used by a mail processing device for computing the postage value, which is franked on a mail piece.

### PRIOR ART

Postal offices regularly change their services or the prices of their services, or they offer new postal services to respond to market needs. As a result, mailing systems suppliers must update the rate tables, which reside in the mailing systems and which are used for calculating the franking value to be printed on a mail piece or for defining the services for the mail piece delivery.

Mailing Systems suppliers need to ensure that the rate tables of all their mailing systems in the field can be updated with a new rate table on the day of a rate change defined by the mail carrier/Postal office. This day of rate change is called the application date. Diverse methods have been described for handling such an update of rate tables in the field.

In the past, exchangeable read-only memories (ROM) have been used, but the physical distribution of these ROMs in the field involves too much effort. So, remote update of the postal rate tables has been proposed from a central data station such as in DE 28 03 982. However, in such a method, updating the mailing systems with new rates requires that, at the time of the update, mailing systems be turned on and be continuously capable of being addressed.

To overcome this issue, U.S. Pat. Nos. 5,606,508 and 5,699,258 describe a method where the new rates are made available in some transmission means external to the mailing system (such as a chip card or cell of a GSM network). When the mailing system is powered on, the new rate table is downloaded from the external transmission means onto the mailing system. This download results in an update of the previous rate table. The new rate table is loaded in the predetermined memory region, where the applicable postage can be read for each mail piece to be franked. This method requires the mailing system to be switched off and on for downloading a new rate table, and requires the new rate table to be made available either physically (chip card) or through a network (GSM network) when the rate table becomes applicable. This requires either a physical distribution (chip cards) or a massive download if the mailing systems are switched on at the same time.

U.S. Pat. No. 6,615,196 describes a method, which overcomes these issues, and which is illustrated in FIG. 4. A new rate table 1a for future use can be downloaded in parallel with the application date 1b for the future use of this new rate table, from a remote server 1 external to the mailing system, into the non-volatile memory 2 of the mailing system. Three pre-determined memory areas are defined in the non-volatile memory 2:
a first area 2a for storing a new rate table for future use, in which the new rate table #b is downloaded from the remote server,
a second area 2b for storing the currently used rate table,
a third area 2c for storing the application date of the future rate table

When the new rate table becomes effective, it replaces the current rate table in the non-volatile memory so that the mailing system can only make use of this new rate table for calculating postages. Periodically, the mailing system compares in step 300 the franking date with the application date stored in the third pre-determined memory area 2c. This periodic comparison would take place each time a franking process is initiated, typically when the data for computing the postage value are gathered. If the application date is the same as or earlier than the franking date as checked in step 310, the rate table needs to be updated. In step 320, the rate table #b in the first pre-determined memory area 2a is transferred in the second pre-determined memory area 2b and overwrites the past rate table #a. The application date in the third pre-determined memory area is inactivated or erased. The new rate table #b is thereafter used in the mailing system, in particular for computing postage values.

This method allows a download of a new rate table in advance of the application date. However, this method has some issues. Mailing systems need to be able to frank mail in advance, for example when a mailing batch needs to be prepared in advance and will be posted later on a particular day. In such a case, the franking date needs to be set manually for this particular date. If this particular mailing batch date happens to be after the application date of the new rate table, the new rate table needs to be used for this particular mailing prepared in advance. Later on, the operator may want to set back the franking date to today's date to continue franking for today's mail. The method described above does not allow for supporting such a situation for franking in advance:
either the mailing batch is franked in advance, but then the mailing system cannot frank any more with today's date because the second pre-determined memory area has been overwritten with the new rate table
or the mailing system does not frank in advance

Post offices and alternative mail carriers currently evolve towards changing postal rates and services more often, in order for example to propose temporary discount rates or to tailor postal rate and services to the customer needs and usage. There is therefore a need in a mailing system to support for the same mail carrier several rate tables, which may become active at different application dates or based on other conditions.

EP1443467 describes a method of alert for the expiration of postal tariffs. In this method, the rate tables are loaded in volatile memory. When a mail franking is initiated, if the application date of a new rate table is identical to or earlier than the franking date, the postal data of this new rate table is compared with the postal data of the current postal data. If one of the compared postal data has been changed, a message alerts the operator of the expiration of postal tariffs. The new postal data are stored in the place of the current postal data when the operator accepts the updating of the postal data.

Such a method has several issues. It requires the loading in volatile memory of several rate tables, whose size are significant for embedded software and tend to increase regularly. With the need for larger numbers of rate tables in a mailing system, such a usage of volatile memory eventually will not be doable. Additionally, the comparison of postal data in a new rate table and in the current rate table, as well as the storage of the new postal data in the place of the current postal data are time consuming processes for a real-time system. The delays resulting from these processes for embedded software, delays all the more significant as there are more rate tables, are not acceptable for an operator who wants to immediately frank his mail.

### SUMMARY OF THE INVENTION

The present invention thus aims to eliminate the above disadvantages and proposes a system and method allowing a mailing system to frank in advance and manage different rate tables stored in the mailing system. The primary object of the method is to support all the different conditions for franking in advance and for rate table changes, and in particular to support the possibility to frank mail in advance using a new future rate table and come back later to franking with today's date and using a previous rate table. The invention has also for object to support a large number of rate tables in a mailing system, which may become active at different application dates or based on other conditions, without excessive usage of volatile memory (RAM). Another object of the invention is to support the download of a new rate table from a remote server onto the mailing system before the application date of this new rate table.

The invention relates to a mailing system, which allows to frank in advance and manage different rate tables stored in the mailing system, and which comprises:
a control module,
a non-volatile memory, which can store more than two rate tables, and, which is accessible by the control module
these more than two rate tables being each associated with an application date stored in the non-volatile memory and accessible by the control module,
a volatile memory accessible by the control module, and storing the active rate table, which is currently used by the mailing system for franking mail pieces.

Preferably, the mailing system comprises a communication module for managing the download of at least one rate table from the remote server into the non-volatile memory of the mailing system. For a rate table download, the rate table is packaged with its associated application date, so that the associated application date is stored in the mailing system in parallel with the rate table.

Advantageously, the mailing system comprises an interface for the operator to be able to manually select a date today or in the future as a franking date, as well as an interface for the operator to be able to set the automatic date advance, including the choosing of the automatic date advance mode and the choosing of a time in the day when the automatic date advance shall take place and the definition of the working days of the week.

According to a feature, this interface further allows the operator to be able to select a mail carrier, and the control module selects the active rate table amongst the rate tables which are stored in said non-volatile memory and which are only for this mail carrier.

According to a main feature of the invention, it is proposed the method allowing a mailing system to frank in advance and manage different rate tables stored in the mailing system, and including the following steps:
provision of a mailing system with a control module, which can store more than two rate tables in a non-volatile memory accessible by this control module,
provision of a volatile memory accessible by the control module, which stores the active rate table that is currently used by the mailing system for franking mail pieces,
selection by the control module of the active rate table amongst the rate tables stored in the non-volatile memory when the mailing system is powered on, and loading of the active rate table by the control module in the volatile memory,
when a determined triggering event initiates the change of the active rate table, selection by the control module of a new active rate table amongst the rate tables stored in the non-volatile memory, based on the franking date defined by the operator or by the mailing system and the application date associated with this new rate table, and loading of said new active table rate in said volatile memory for franking.

The events initiating the change of the active rate table after the mailing system has been powered on include, but may not be limited to, the following events:
a day change,
a franking date change, or
exit from sleep of the mailing system.

The change of the active rate table takes place if one of the application dates stored in non-volatile memory (RAM) fulfils the following conditions:
the application date is earlier than or identical to the franking date,
the application date is strictly later than the application date of the current rate table.

If the above conditions are fulfilled, a new rate table must be loaded in volatile memory as the active rate table. The control module of the mailing system selects, amongst the rate tables whose associated application dates fulfil the above conditions, the rate table whose associated application date is the nearest to the franking date.

The initiation of the change of the active rate table and the selection of the active rate table is not limited to the above triggering events and application date analysis, but can be based on other conditions such as for example volume of processed mail triggering a particular rate discount.

### BRIEF DESCRIPTION OF THE DRAWINGS

The foregoing in other objects features and advantages of the invention will be apparent from the following more specific description of a preferred embodiment of the invention as illustrated in the accompanying drawings in which:

FIG. 1 illustrates a system for rate table updating and rate table selection according to the invention.

FIG. 2 shows a diagram illustrating the different steps of the method of the invention during the powering on of the mailing system.

FIG. 3 shows a diagram illustrating the different steps of the method of the invention when the mailing system is in normal operation after the mailing system has been powered on.

FIG. 4 illustrates a rate table update process of the prior art.

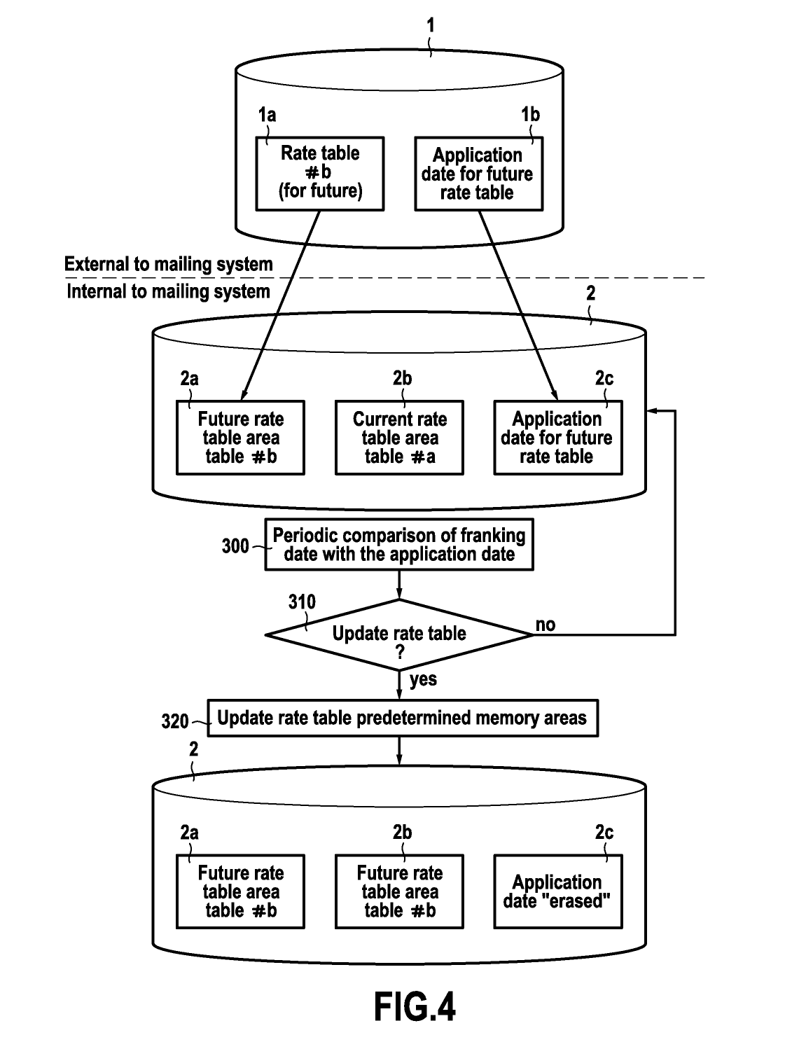

### DETAILED DESCRIPTION

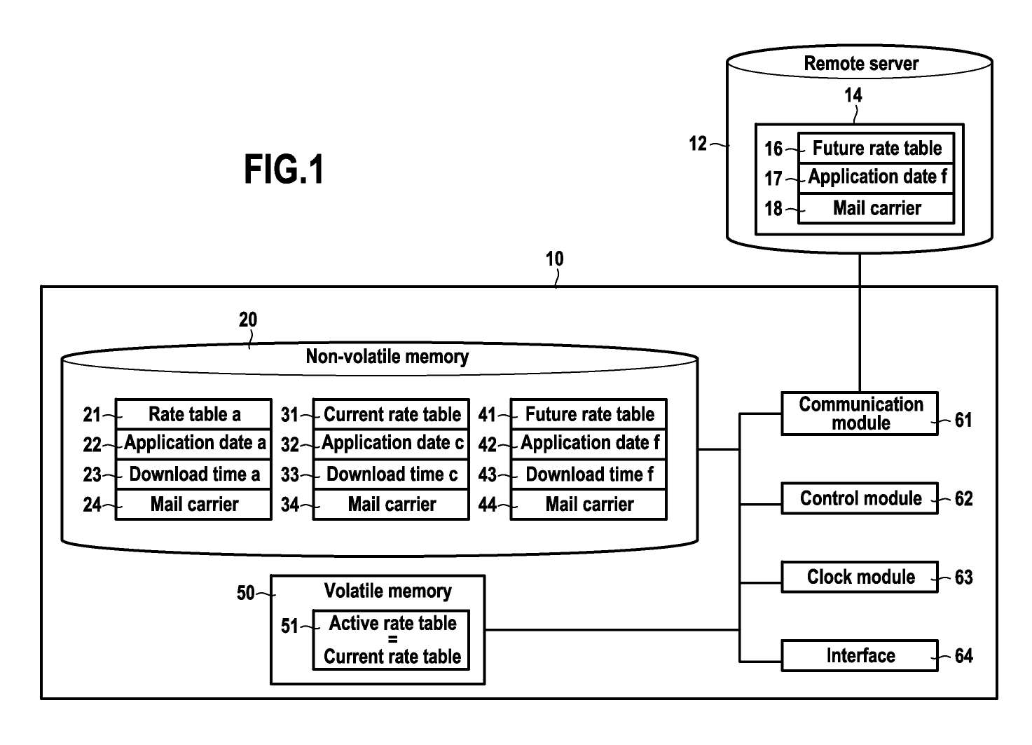

The invention for the combined management of the rate tables and of the date advance function by the mailing system will now be further explained and illustrated in FIGS. 1 to 3. The proposed system architecture and method allow for example:
the operator or the mailing system to select a particular date in the future for franking some mail in advance,
the mailing system to select the new rate table, if this particular selected franking date is after the application date of this new rate table,
the operator to frank some mail in advance using the new rate table,
the operator to (re-)select today's date,
the mailing system to (re-)select the past rate table, which was in use before the selection of a date in the future for franking,
the operator to frank mail with today's date using the past rate table.

These proposed system architecture and method also allow to manage a large number of rate tables, which can be selected based on a multiplicity of possible conditions and a multiplicity of triggering events.

The system for rate table updating and for rate table selection illustrated in FIG. 1 comprises a mailing system 10 connected with a remote server 12, which is used for downloading rate tables onto the mailing system installed in the field.

The download of a new rate table from the remote server 12 onto the mailing system 10 is scheduled by the remote server 12 in advance of the application date of the new rate table. This scheduling in advance allows the remote server 12 to spread the rate download onto all the mailing systems in the field over a period in order to avoid any download bottlenecks, especially just before the application date of the new rate table. Preferably, the download of a new rate table is scheduled during the night or when the mailing system is in sleep mode. This way, the rate table download is seamless for the operator. In particular, on the day of the rate application, when the operator powers on the mailing system, no rate table download should need to occur as the download would have taken place in advance, and the operator can use the mailing system without any delay.

Advantageously, several rate tables can be downloaded in a single download operation, i.e. at least one rate table can be downloaded from the remote server into the non-volatile memory of the mailing system.

Preferably, a rate table is packaged into a rate packaged file 14, which can be stored in the remote server 12, where it is made available for download by the remote server 12. Such a rate packaged file 14 includes:
a rate table 16 for future use in the mailing system, called future rate table in FIG. 1,
an application date 17 associated with this rate table, called application date f in FIG. 1. The application date defines the day when the future rate table 16 must be in use in the field,
preferably, the identification 18 of the mail carrier associated with this rate table.

The mailing system 10 comprises:
a non-volatile memory 20, preferably a flash memory, which can store at least two rate tables 21, 31, 41 for the same mail carrier as well as the following data: an application date 22, 32, 42, a download time 23, 33, 43, and preferably a mail carrier identification 24, 34, 44, data which are associated with each rate table,
the rate tables include the current rate table 31 used by the mailing system 10 for franking mail pieces, and which can include several future rate tables 41 and eventually some past rate tables 21,
the application date for each rate table includes the application date 32 of the current rate table used by the mailing system for franking mail pieces, and possibly including several application dates defining the date for the use of future rate tables 42 and eventually for the use of past rate tables 22,
the download time associated with each rate table corresponds to the time when the download of the associated rate table took place from the remote server 12, and which is stored in the non-volatile memory 20,
the mail carrier identification associated with each rate table allows a control module to identify the mail carrier of each rate table stored in the non-volatile memory 20,
a volatile memory 50, preferably a RAM, which stores a active rate table 51 that is currently used by the mailing system for franking mail pieces,
a communication module 61, which manages the download of a packaged files 14 from the remote server 12 onto the mailing system 10,
the control module 62, which manages the updating of the active rate table 51 in the volatile memory 50 and the selection of the active rate table 51 in the non-volatile memory 20,
a clock module 63, which can provide the current date and time to the control module 62 and to the communication module 61.

Advantageously, the mailing system comprises an user interface (HIM 64) for the operator to be able to manually select a date today or in the future as a franking date, as well as to set the automatic date advance, including:
an interface to chose the automatic date advance mode,
an interface to chose a time in the day when the automatic date advance shall take place,
an interface to define the working days of the week.

Advantageously, the non-volatile memory 20 also can store rate tables for other mail carriers. In an embodiment, to support different mail carriers, the mailing system 10 provides an interface for the operator to be able to select the mail carrier. The combined management of the rate tables and of the date advance function proposed by this invention can apply when the rate tables of several mail carriers are stored in the mailing system 10. A man skilled in the art will deduce the corresponding operation, integrating the principle that for a given mail carrier selected by the operator only rate tables for this mail carrier can be selected amongst the rate tables stored in the non-volatile memory 20.

The operation according to the invention must be split into two cases according to the mailing system conditions: when the mailing system is in the phase of powering on and when the mailing system is in normal operation after the mailing system has been powered on.

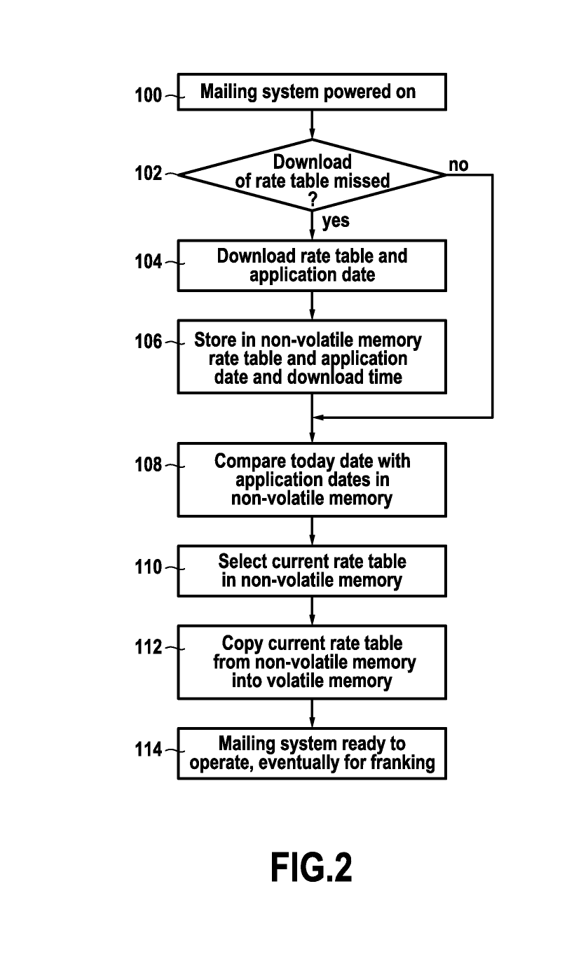

During the powering on of the mailing system, the invention operates as described below, and as illustrated on FIG. 2 for the different operation steps and on FIG. 1 for the different involved components.

Following on the powering on of the mailing system in step 100, the control module 62 checks in step 102, whether the download of a new rate table has been missed. A rate download should not be missed for standard regular usage of the mailing system. However, if the mailing system has been powered down for a long time, the download of a new rate may have been missed. If the download of a new rate table has been missed, the communication module 61 retrieves in step 104 the future rate table 16 and the associated application date 17 and eventually the mail carrier identification 18, which are made available by the remote server 12. In step 106, the control module 62 stores the future rate table 16 and the associated application date 17 and eventually the mail carrier identification 18 in the non-volatile memory 20. Moreover the control module 62 retrieves the date and time of the rate table download from the clock module 63 and stores this date and time as the download time 43 in the non-volatile memory 20 in association with the downloaded rate table 41. Rate tables and application dates already stored in the non-volatile memory 20 are not affected by this download.

At the powering on of the mailing system, no rate table is loaded yet in the volatile memory 50. The mailing system needs to load an active rate table for operating, and in particular for franking mail pieces. In step 108, in order to copy the correct rate table from the non-volatile memory 20 into the volatile memory 50, the control module 62 compares the franking date with the application dates associated with the rate tables stored in the non-volatile memory 20. Preferably, at the powering on of the mailing system, the franking date is defined as the today date. In step 110, the control module 62 selects the rate table, whose associated application date is earlier than the franking date and the nearest to the franking date, amongst the rate tables stored in the non-volatile memory 20. This selected rate becomes the active rate table, i.e. the one currently used by the mailing system. In step 112, the control module 62 copies the current rate table from the non-volatile memory 20 into the volatile memory 50. Thereafter, in step 114, the mailing system is ready for operating with the current rate table, and ready for eventually franking mail pieces.

In an embodiment, the mailing system can support different mail carriers. Preferably, one mail carrier is pre-selected by default during the powering on of the mailing system, and the mailing system provides the user interface 64 for the operator to be able to pre-select a mail carrier to be used as default during the powering on of the mailing system. In step 108, the control module 62 compares the franking date only with the application dates stored in the non-volatile memory 20, whose associated rate tables are for this pre-selected mail carrier. In step 110, the control module 62 selects the current rate table amongst rate tables stored in the non-volatile memory 20, which are only for this pre-selected mail carrier.

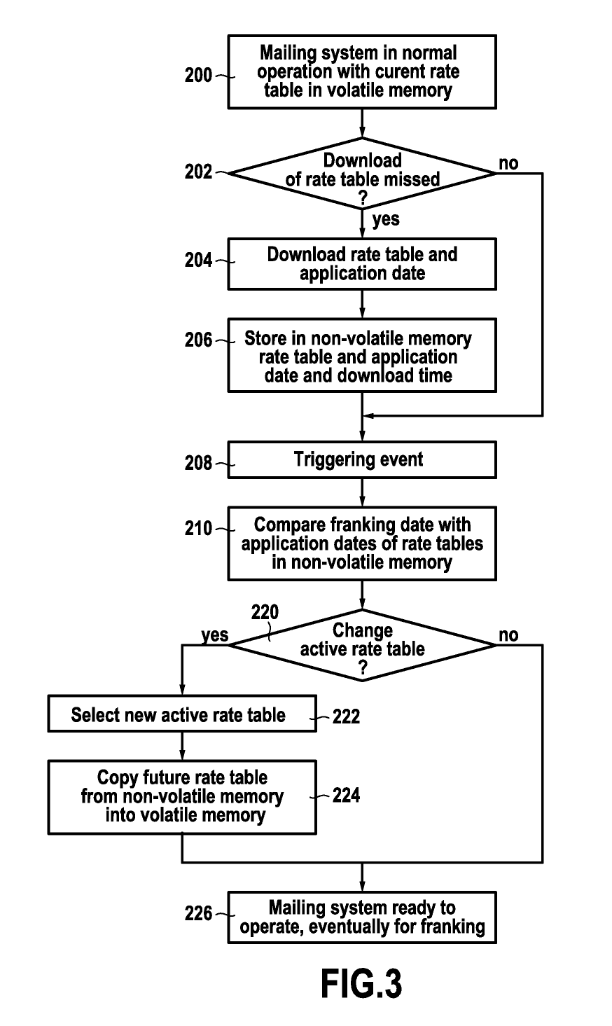

Once the mailing system has been powered on and is in normal operation, the invention operates as described below, and as illustrated on FIG. 3 for the different operation steps and on FIG. 1 for the different involved components.

In step 200, when the mailing system is in normal operation, an active rate table 51 is loaded in the volatile memory 50 and is currently used for the mailing system operation, and in particular for franking mail pieces. This active rate table 51 results from a copy of the current rate table 31, which is stored in the non-volatile memory 20, and which was selected by the control module 62 either during the powering on of the mailing system as described above, or during a change of the active rate table as it will be described below.

During normal operation, if the download of a new rate table has been missed, its download from the remote server 12 onto the mailing system 10 is required. In step 202, the control module 62 checks whether the download of a new rate table has been missed by the mailing system. If the download of a new rate table has been missed, the communication module 61 retrieves in step 204 the future rate table 16 and the associated application date 17 and eventually the mail carrier identification 18, which are made available by the remote server 12. In step 206, the control module 62 stores the future rate table 16 and the associated application date 17 and eventually the mail carrier identification 18 in the non-volatile memory 20. Moreover the control module 62 retrieves the date and time of the rate table download from the clock module 63 and stores this date and time as the download time 43 in the non-volatile memory 20 in association with the downloaded rate table 41. Rate tables and application dates already stored in the non-volatile memory 20 are not affected by this download. Preferably, this rate table download is scheduled during the night or when the mailing system is in sleep mode. Advantageously, a mechanism internal to the mailing system ensures for a regular erasing of past rate tables, which cannot be used anymore by the mailing system.

In step 208, a determined triggering event initiates the change of the active rate table. A common triggering event is the day change, when the date of the new day may become the same as the application date of one of the rate tables stored in the non-volatile memory 20 other than the current rate table. Another triggering event is the exit from sleep mode, because the mailing system does not check for day change while it is in sleep mode. The date at the exit from sleep may have become the same as or later than the application date of one of the rate tables stored in the non-volatile memory 20 other than the current rate table. Another triggering event is the change of the franking date, when the changed franking date may become the same as or later than the application date of one of the rate tables stored in the non-volatile memory 20 other than the current rate table.

According to an embodiment, the franking date change which triggers the initiation of a rate table change by the mailing system, results from the definition of a new franking date. The definition of a new franking date can be achieved manually by the operator or automatically by the mailing system.

Based on postal regulations, the franking date may be defined as today or in the future within some limitations, which are country dependant.

According to a further embodiment, for the manual definition of the franking date, the mailing system provides an interface so that the operator can manually select a date today or in the future as a franking date. The selection of a franking date in the future allows the operator to prepare in advance a mailing that he will post at a later date.

Typically, in companies, the mail is collected by a mail carrier agent at a specific time in the day: the collection time, which may be quite early in the afternoon. Any mail franked after this collection time, will be posted on the day of the next collection, and has to be franked with the future date of the day of the next collection. As the default franking date on a mailing system generally is today's date, there is a genuine risk after the collection time that operators do not chose the right future date and frank with today's date. The automatic date advance feature, when activated, can prevent such a risk. According to another feature, the automatic definition of the franking date by the mailing system includes the following steps:
the mailing system provides an interface allowing the operator to chose the automatic date advance mode,
the mailing system, once the automatic date advance mode is set, provides an interface allowing the operator to chose a time in the day for date advance, called the automatic date advance time, when the automatic date advance shall take place,
when the time for automatic date advance time is reached during the day, the mailing system automatically defines the franking date as the next working day.

Preferably, when the automatic date advance feature is activated, the mailing system prompts a proposal for the operator to advance the franking date to the next working day, so that the operator can refuse this automatic date advance.

According to a further embodiment, the next working day definition by the mailing system includes the following steps:
the mailing system provides an interface allowing the operator to define the working days of the week,
when the time for automatic date advance time is reached during the day, the mailing system automatically defines the next working day based on the working days of the week which have been defined by the operator.

Following on the initiation of the change of the active rate table by the triggering event in step 208, the control module 62 compares in step 210 the franking date with the application dates, such as 22 or 32 or 42 in FIG. 1, of the rate tables stored in the non-volatile memory 20. The change of the active rate table only takes place if one of the application dates associated with the rate tables stored in non-volatile memory 20 fulfils the following conditions, which are checked in step 220 by the control module 62:
the application date is earlier than or identical to the franking date,
the application date is strictly later than the application date of the current rate table, which is the active rate table currently loaded in the volatile memory 50.

If the above conditions are fulfilled, a new rate table must be loaded in volatile memory 50 as the active rate table. In step 222, the control module 62 selects in the non-volatile memory 20, amongst the rate tables whose associated application dates 22, 42 fulfil the above conditions, the rate table whose associated application date is the nearest to the franking date. In step 224, the control module 62 copies this new rate table 41 into the volatile memory 50. This future rate table 41 becomes the active rate table 51, and overwrites the current rate table 31 which was previously loaded in the volatile memory 50. Thereafter, in step 226, the mailing system is ready for operating with this new future rate table, and ready for eventually franking mail pieces.

Advantageously, in order to distinguish between rate tables which are candidates for selection to replace the active rate table because they have the same application date, the control module 62 uses the download time associated with each rate table. These download times were stored in the non-volatile memory 20 by the control module 62 at the time of the download of the associated rate tables from the remote server 12. In step 222, the control module 62 selects, amongst these rate tables with the same application date, the rate table for which the associated download time is the latest. The existence of two or more rate tables stored in the non-volatile memory 20 with the same application date and for the same mail carrier typically may occur when a change is needed for a rate table already downloaded onto the mailing system. Such a change may for example be required because of an error has been identified in the rate table already downloaded onto the mailing system. In such a case, a second rate table is downloaded onto the mailing system at a later date with the same application date. The download time information allows the mailing system to select the second rate table with the required change.

In an embodiment, the mailing system provides an interface for the operator to be able to select a mail carrier. This feature allows the operator to print different marks on the mail pieces depending on the mail carrier that he chooses to use. Once a mail carrier is selected, only the rate tables corresponding to this mail carrier and identified by the mail carrier identification which is stored in the non-volatile memory 20 in association with the rate tables, can be selected. In step 210, the control module 62 compares the franking date with only the application dates stored in the non-volatile memory 20, for which the associated rate tables are for the selected mail carrier. In step 222, the control module 62 selects the active rate table amongst rate tables stored in the non-volatile memory 20, which are only for the selected mail carrier.

1. Method allowing a mailing system to frank in advance and manage different rate tables stored in the mailing system, and including the steps:
provision of a mailing system with a control module, which can store more than two rate tables in a non-volatile memory accessible by said control module,
provision of a volatile memory accessible by said control module, which stores the active rate table that is currently used by the mailing system for franking mail pieces,
selection by said control module of said active rate table amongst the rate tables stored in said non-volatile memory when the mailing system is powered on, and loading of said active rate table by said control module in said volatile memory,
when a determined triggering event initiates the change of the active rate table, selection by said control module of a new active rate table amongst the rate tables stored in said non-volatile memory, based on the franking date defined by the operator or by the mailing system and the application date associated with said new rate table, and loading of said new active table rate in said volatile memory for franking.

2. Method of claim 1, wherein the determined triggering events initiating the change of the active rate table after the mailing system has been powered on include one of the followings:
a day change,
a franking date change, or
exit from sleep of the mailing system.

3. Method of claim 2, wherein the franking date is defined manually by the operator or automatically by the mailing system.

4. Method of claim 3, wherein, for the manual definition of the franking date, the mailing system provides an interface so that the operator can manually select a date today or in the future as a franking date.

5. Method of claim 3, wherein the automatic definition of the franking date by the mailing system includes the steps:
the mailing system provides an interface allowing the operator to chose the automatic date advance mode,
the mailing system, once the automatic date advance mode is set, provides an interface allowing the operator to chose a time in the day for date advance (automatic date advance time) when the automatic date advance shall take place,
when said time for automatic date advance time is reached during the day, the mailing system automatically defines the franking date as the next working day.

6. Method of claim 5, wherein the next working day definition by the mailing system includes the steps:
the mailing system provides an interface allowing the operator to define the working days of the week,
when the time for automatic date advance time is reached during the day, the mailing system automatically defines the next working day based on the working days of the week, which have been defined by the operator.

7. Method of claim 1, wherein the change of the active rate table takes place if one of the application dates associated with the rate tables stored in said non-volatile memory fulfils the following conditions:
the application date is earlier than or identical to the franking date,
the application date is strictly later than the application date of the current rate table.

8. Method of claim 7, wherein the control module of the mailing system selects, amongst the rate tables whose associated application dates fulfill said above conditions, the rate table whose associated application date is the nearest to the franking date.

9. Method of claim 8, wherein the selection by the mailing system of the new active rate table includes the steps:
for all the rate tables which are candidates for selection to replace the active rate table because they have the same application date, the control module compares the different download times, which are associated with each rate table, and which are stored in said non-volatile memory, and which correspond to the times of download of the associated rate tables from a remote server,
the control module selects, amongst the rate tables with the same application date, the rate table whose associated download time is the latest.

10. Mailing system allowing to frank in advance and manage different rate tables stored in the mailing system, and comprising:
a control module,
a non-volatile memory, which can store more than two rate tables, and, which is accessible by said control module,
said more than two rate tables being each associated with an application date stored in said non-volatile memory and accessible by said control module,
a volatile memory accessible by said control module, and storing the active rate table, which is currently used by the mailing system for franking mail pieces.

11. Mailing system according to claim 10, wherein said more than two rate tables being each associated with a download time stored in said non-volatile memory and accessible by said control module, and which corresponds to the time when the download of the associated rate table took place from a remote server.

12. Mailing system according to claim 10, further comprising a communication module (61) for managing the download of at least one rate table from said remote server into said non-volatile memory.

13. Mailing system according to claim 10, further comprising an interface for the operator to be able to manually select a date today or in the future as a franking date.

14. Mailing system according to claim 10, wherein said interface further allows the operator to be able to choose the automatic date advance mode, to choose a time in the day for date advance when the automatic date advance shall take place, and to define the working days of the week.

15. Mailing system according to claim 12, wherein said interface further allows the operator to be able to select a mail carrier, and the control module selects the active rate table amongst the rate tables which are stored in said non-volatile memory and which are only for said mail carrier.
